(19) United States
(12) Patent Application Publication
(10) Pub. No.: US 2014/0298297 A1
(43) Pub. Date: Oct. 2, 2014

(54) AUTOMATIC FEATURE-DRIVEN TESTING AND QUALITY CHECKING OF APPLICATIONS

(71) Applicant: FUJITSU LIMITED, Kanagawa (JP)

(72) Inventors: Mukul R. Prasad, San Jose, CA (US); Razieh Nokhbeh Zaeem, Austin (UX)

(73) Assignee: Fujitsu Limited, Kanagawa (JP)

(21) Appl. No.: 13/851,818

(22) Filed: Mar. 27, 2013

(51) Int. Cl. G06F 11/36

(52) U.S. Cl. CPC G06F 11/3684
USPC 717/125

(57) ABSTRACT

A method of feature-driven testing by one or more computing devices includes determining a graphical user interface (GUI) model of an application, determining an application-independent feature of a platform, augmenting the GUI model to reflect the application-independent feature resulting in an augmented model, and determining a test case from the augmented model. The test case includes the application-independent feature. The application is to be executed on the platform. The GUI model includes states and transitions.

### TECHNICAL FIELD

The present invention generally relates to software verification and, more particularly, to automatic feature driven testing and quality checking of applications.

### BACKGROUND

A software application may include any number of modules (e.g., classes, functions, procedures, subroutines, or code blocks), and each module may be tested or validated individually. A software module may be tested or validated manually or automatically. In the former case, a person (e.g., a software testing engineer) may manually design test cases for the software module based on the design specification of the module, execute the module under the test cases, and check for module behavior or output that does not agree with the specification over the test cases. In the latter case, a software-testing tool, implemented as computer software or hardware, may automatically generate test cases for a software module under test, execute the module under test while simulating the test cases, and check for module behavior or output that does not agree with the test cases. The sheer complexity of modern software often renders manual generation or design of test cases inadequate for completely testing the software.

Event-driven programs, i.e. a program in which the flow of the program is determined by events, are becoming increasingly more common. Event-driven programs are commonly used in user applications, such as in applications that provide graphical user interfaces (GUI). Additionally, event-driven programs may be used in mobile applications operating on mobile devices, such as smart phones and tablets, to provide users a GUI and other functionality. Using event-driven programs may ease use of mobile devices and other devices for users.

### SUMMARY

In one embodiment, a method for feature-driven testing, by one or more computing devices, includes determining a graphical user interface (GUI) model of an application, determining an application-independent feature of a platform, augmenting the GUI model to reflect the application-independent feature resulting in an augmented model, and determining a test case from the augmented model. The test case includes the application-independent feature. The application is to be executed on the platform. The GUI model includes states and transitions.

In another embodiment, a system includes a computer-readable medium including computer-executable instructions and one or more processors coupled to the computer-readable medium and operable to read and execute the instructions. The one or more processors are operable when executing the instructions to determine a graphical user interface (GUI) model of an application, determine an application-independent feature of a platform, augment the GUI model to reflect the application-independent feature resulting in an augmented model, and determine a test case from the augmented model. The test case includes the application-independent feature. The application is to be executed on the platform. The GUI model includes states and transitions.

In yet another embodiment, an article of manufacture includes a computer-readable medium and computer-executable instructions carried on the computer-readable medium. The instructions are readable by a processor. The instructions, when read and executed, cause the processor to determine a graphical user interface (GUI) model of an application, determine an application-independent feature of a platform, augment the GUI model to reflect the application-independent feature resulting in an augmented model, and determine a test case from the augmented model. The test case includes the application-independent feature. The application is to be executed on the platform. The GUI model includes states and transitions.

The object and advantages of the invention will be realized and achieved by means of the elements and combinations particularly pointed out in the claims. It is to be understood that both the foregoing general description and the following detailed description are exemplary and explanatory and are not restrictive of the invention, as claimed

### BRIEF DESCRIPTION OF THE DRAWINGS

For a more complete understanding of the present invention and its features and advantages, reference is now made to the following description, taken in conjunction with the accompanying drawings, in which:

FIG. 1 is an illustration of an example embodiment of a system for automatic feature-driven testing and quality checking of applications;

FIG. 2 is an illustration of an example embodiment of an augmented graphical user interface model;

FIG. 3 is an illustration of an example method for test suite extraction;

FIG. 4 illustrates an example embodiment of a method for determining a new test path given a node; and

FIG. 5 is an illustration of an example embodiment of a method for automatic feature-driven testing and quality checking of applications.

### DETAILED DESCRIPTION

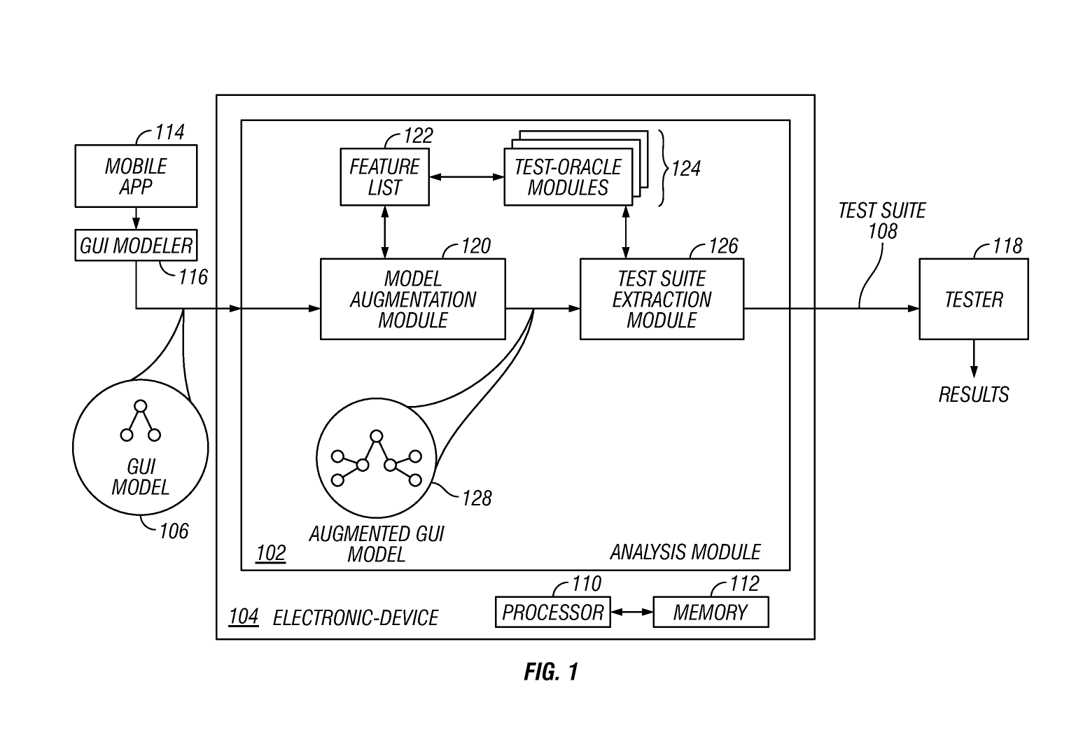

FIG. 1 is an illustration of an example embodiment of a system 100 for automatic feature-driven testing and quality checking of applications. Such applications may include, for example, applications designed for use on a specific target platform. The application may include, for example, mobile applications for a category of or specific mobile operating systems or devices. A given application may be developed with programmatic functionality specific to the application. However, the application may also include features, functionality, or other aspects that relate to the platform in which the application will be deployed. Such features, functionality, or other aspects may be independent of the specific applications that are to be deployed to the system such that all such applications may implement them to work in the same or similar manners, no matter which application is being used. The features, functionality, or other aspects may need to be implemented by the respective applications, but such features may not otherwise change the underlying operation of the application. System 100 may provide testing and quality checking of applications such that platform-specific features and the like may be tested across many different applications.

System 100 may include an analysis module 102. Analysis module 102 may be implemented in any suitable manner, such as by an application, function, code, shared library, script, executable, object code, instructions, hardware, software, or any suitable combination thereof. Analysis module 102 may be configured to execute on any suitable device, such as electronic device 104. Electronic device 104 may include, for example, a computer, mobile device, server, blade, or other suitable entity. Although a single electronic device 104 is shown in FIG. 1, system 100 may include any suitable kind or number of electronic devices for carrying out the configuration and operation of system 100.

Electronic device 104 may include a processor 110 coupled to a memory 112. Some or all of analysis model 102 may be embodied in logic or instructions resident in memory 112 for execution by processor 110. Processor 110 may include, for example, a microprocessor, microcontroller, digital signal processor (DSP), application specific integrated circuit (ASIC), or any other digital or analog circuitry configured to interpret and/or execute program instructions and/or process data. Processor 110 may interpret and/or execute program instructions and/or process data stored in memory 112. Memory 112 may comprise any system, device, or apparatus configured to retain program instructions and/or data for a period of time (e.g., computer-readable media).

Analysis module 102 may be configured to accept a graphical user interface (GUI) model 106 as input. Analysis module 102 may be configured to provide a test suite 108 as its output. Analysis module 102 may be configured to analyze GUI model 106 and, based upon the analysis, generate test suite 108. Such testing based upon GUI model 106 may be used during development of the application represented by GUI model 106. Testing may be performed to determine whether or not the application represented by GUI module 106 includes the functionality and features as expected or desired by the developer of the application. Analysis of GUI model 106 may thus be used to identify one or more features of the underlying application that may not function as desired and that may accordingly be modified such that the application may function as desired. The features identified by analysis module 102 may include features that are independent of the rest of the operation of the underlying application, and may include features that are common to all applications of a given platform.

GUI model 106 may include an abstraction of the operation of an application. Such an application may include an event-driven application, wherein upon various user-inputs or other events, the application changes its state. GUI model 106 may include indications of one or more states of operation. Between such states of operation, GUI model 106 may include edges or transitions indicating user input or other actions that cause the state of the application to change operation. Thus, GUI module 106 may include a finite-state model of the GUI behavior of the underlying application. Each state of operation may denote an abstract representation of a screen or a state of a screen that a user interacts with while using the application.

GUI model 106 may be created based upon the application-specific operations associated with the application on which it is based. In one embodiment, GUI model 106 may not include operations with respect to platform-level actions. Such platform-level actions are described in greater detail below. GUI model 106 may exclude such platform-level actions because including them may cause the GUI model to be too unwieldy or cumbersome for analysis.

GUI model 106 may be determined in any suitable manner. For example, GUI model 106 may be determined or set by a developer of an application, such as application 114, represented by GUI model 106. In another example, GUI model 106 may be the output of a module configured to generate state graphs, state machines, or other representations of an application, based on the code of such an application. Such a module may include, for example, GUI modeler 116. GUI modeler 116 may be implemented in any suitable manner or way for generating a GUI module 106 based upon an application 114. GUI modeler 116 may be implemented within system 100, on electronic device 102, or in any other suitable device or location.

Application 114 may include any suitable application for which analysis module 102 may provide platform-level analysis. Application 114 may be implemented by, for example, an application, function, code, shared library, script, executable, object code, instructions, software, or any suitable combination thereof. Application 114 may include event-driven operations, user-touch screens, or other features. In one embodiment, application 114 may include a mobile application. In another embodiment, application 114 may include a platform-specific application. Thus, application 114 may be configured to operate on a particular type or class of devices or environments. Application 114 may be configured to operate on a specific device or a specific subclass of devices. For example, application 114 may be configured to operate on ANDROID-based smartphones, ANDROID-based tablets, IOS-based smartphones, IOS-based tablets, WINDOWS-based computers, WINDOWS-based tablets, or WINDOWS-based smartphones. The platform for application 114 may also include a navigation system, an entertainment system, or a vehicle such as an automobile. These are given for example purposes only. Application 114 may be input into GUI modeler 116, resulting in GUI module 106.

Upon conducting its operations, analysis module 102 may output test suite 108 to tester 118. Test suite 108 may include a set of sequences, wherein each sequence includes indications of commands, operations, or other actions to be performed upon application 114. Furthermore, each such sequence may include an expected output. Tester 118 may be configured to execute such sequences and evaluate whether the operations of application 114 match the specified or expected behavior. In one embodiment, tester 118 may be configured to evaluate the overall behavior of application 114. In another embodiment, tester 118 may be configured to evaluate the platform-specific operations that may be independent of the specific functionality of application 114. Tester 118 may determine the evaluations to be performed based upon the contents of test suite 108. Thus, test suite 108 may be generated to include platform-specific operations that may be independent of the specific functionality of application 114. Tester 118 may be implemented in any suitable manner or way for testing test suite 108 and outputting its results. Tester 118 may be implemented within system 100, on electronic device 102, or in any other suitable device or location.

In order to convert GUI model 106 into test suite 108 with sequences for testing application-independent and platform-wide features and operations, analysis module 102 may be configured to enhance, add to, or otherwise augment GUI model 106. Analysis module 102 may be configured to transform GUI model 106 into, for example, augmented GUI model 128. Based on such augmented GUI model 128, analysis module 102 may be configured to extract test sequences from the enhancements made in augmented GUI model 128 over GUI model 106 such that the application-independent and platform-wide features and operations are tested by test suite 108.

Analysis module 102 may include any suitable number or kind of components to perform is analysis of GUI model 106. For example, analysis module 102 may include a model augmentation module 120, feature lists 122, test oracle modules 124, and a test suite extraction module 126. Each of model augmentation module 120, feature lists 122, test oracle modules 124, and test suite extraction module 126 may be located on electronic device 102 or any other suitable electronic device communicatively coupled to analysis module 102. Furthermore, each of model augmentation module 120, feature lists 122, test oracle modules 124, and test suite extraction module 126 may be implemented in any suitable manner such as by an application, function, code, shared library, script, executable, data structure, file, database, object code, instructions, hardware, software, or any suitable combination thereof. Some or all of model augmentation module 120, feature lists 122, test oracle modules 124, and test suite extraction module 126 may include code, instructions, or other data resident on memory 112 for execution by processor 110 to provide the functionality described herein. Furthermore, each of model augmentation module 120, feature lists 122, test oracle modules 124, and test suite extraction module 126 may include such code resident on other memories for execution by processor 110 or another suitable processor.

Model augmentation module 120 may be configured to receive GUI model 106 and enhance, augment, or otherwise add to GUI model 106 to add modeling of platform-based behavior. Such behavior may be independent of the specific application for which GUI model 106 represents.

The platform-based behavior may include operations, commands, or other activities that are to be conducted independent of the specific behavior of a given application on the platform. Thus, these behaviors may be considered application-independent, such that the resultant operation should be the same no matter which application is being executed on the platform and, in some instances, no matter which screen of an application is being executed. The behaviors may represent a mode of interacting with the application supported by the platform or device that is independent of the specific application thus might not be included within GUI model 106. Thus, the behaviors might be defined in terms of GUI interactions. The behaviors may not be reflected within the application-specific lines of codes, branches, etc. within the application.

Such platform-based behavior may include, for example: touch-screen gestures such as scrolling, swiping a screen, pinching a screen (zooming out), spreading a screen (zooming in); rotating a screen based on physical position or rotation of the device; restarting, stopping, killing, or pausing the application based upon pressing a device button; activating a platform-wide “back” button; or activating a platform menu. These behaviors often are related to the control of presentation or navigation of the platform. Furthermore, these behaviors are not linked to the core logic of the underlying function. The behaviors may include application-agnostic or application-independent operation that may be checked across many different applications. For example, rotating a screen twice may result in the presentation of the original screen. Such a rotation operation and check may apply to any application or subscreen thereof. In another example, pressing a back button should return an application to a previous screen, which may apply to any application or subscreen thereof. While these behaviors are defined by the platform, applications for the platform may be expected to correctly support such features.

Model augmentation module 120 may be configured to access feature list 122 and test oracle modules 124 to determine, for a given application or screen thereof, what application-independent features are to be tested and, furthermore, how they should be tested. Feature list 122 may access test oracle modules 124, which in turn may be used to actually perform tests to determine how a given feature is to be tested. Feature list 122 may return a list of features for which representations are to be added to GUI model 106. A feature may be defined by, for example, an indication of the states or the kinds of states in a GUI model on which the feature is applicable. For example, a kill option may not be available in certain protected states. Furthermore, some screens may be designed so as not to support rotation or zooming. In addition, a back-command may be inapplicable to a root state of an application. A feature may be further defined by a sequence of commands actions that may be a predicate for exercising the feature. In addition, a feature may be further defined by one or more of test oracle modules 124, which may define, for a given feature, expected behavior. Such definitions may be applicable across multiple applications and may be independent of a given application or a screen thereof.

Given the features—and states, predicate sequences, and logical rules thereof—model augmentation module 120 may be configured to augment GUI model 106 to incorporate additional transitions based on the features. The result may include augmented GUI model 128. In one embodiment, augmented GUI model 128 may add no additional states to GUI model 128.

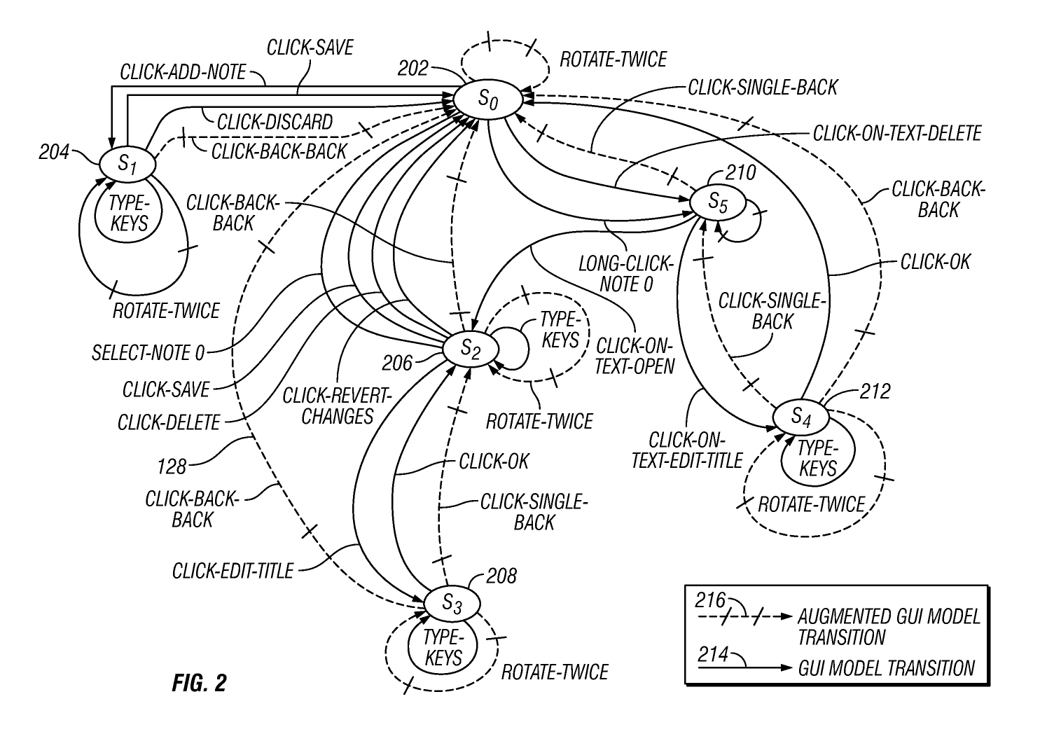

FIG. 2 is an illustration of an example embodiment of an augmented GUI model 128. For the purposes of the example of FIG. 2, augmented GUI model 128 may be based upon an application such as a notepad application. Augmented GUI model 128 may include one or more states 202, 204, 206, 208, 210, 212. Furthermore, augmented GUI model 128 may include one or more transitions 214 that were originally present in GUI model 106 between such states. In addition, augmented GUI model 128 may include added transitions 216 that were added during the operation of model augmentation module 120 to create augmented GUI model 128 from GUI model 106. Thus, GUI model 106 may include states 202, 204, 206, 208, 210, 212 and transitions 214.

Each transition 214 between one of states 202, 204, 206, 208, 210, 212 may represent a GUI action selected by a user in the notepad application. For example, from state S0 202, an initial screen or state of the notepad application, a user may have: clicked an “Add note” option to add a note, moving operation to state S1 204; selected an option for Note0, moving operation to state S2 206; clicked on text to delete, moving operation to state S5 210; or clicked for a long time on “Note0”, moving operation to state S5 210.

In state S1 204, a user may have: typed keys, resulting in operation staying at state S1 204; clicked a “Save” button, moving operation to state S0 202; or clicked a “Discard” button, moving operation to state S0 202.

In state S2 206, a user may have: typed keys, resulting in operation staying at state S2 206; clicked an “Edit title” button, moving operation to state S3 208; clicked a “Save” button, moving operation to state S0; clicked a “Delete” button, moving operation to state S0; or clicked a “Revert changes” button, moving operation to state S0.

In state S3 208, a user may have: typed keys, resulting in operation staying at state S3 208; or clicked an “OK” button, moving operation to state S2 206.

In state S5 210, a user may have typed keys, resulting in operation staying at state S5 210; clicked a “Text open” button, moving operation to state S2 206; or clicked a “Text edit title” button, moving operation to state S4 212.

In state S4 212, a user may have typed keys, resulting in operation staying at state S4 212; or clicked an “OK” button, moving operation to S0 202.

These may represent the contents of GUI model 106. Upon receipt of GUI model 106, model augmentation module 120 may have determined one or more feature transitions from feature list 122 to apply to GUI model 106. Such added transitions 216 may include operations associated with rotation and pressing of a back button. Feature list 122 may define that, given a state, two rotation operations should yield the same state. Furthermore, feature list 122 may define that a single press of a back button may cause a state to return to the state that preceded it. In addition, feature list 122 may define that a double-press of a back button may cause a state to return to two previously called states. In some cases, such a double-press of a back button may cause the application to return to its root state.

Augmented GUI model 128 may illustrate these added transitions 216 reflecting platform operations that are application-independent. Model augmentation module 120 may have placed added transitions 216 into GUI model 106 without evaluation of the existing transitions, but only according to the evaluation of states as root or non-root.

Accordingly, in state S0 202, a user may have twice caused a rotation during operation of state S0 202, resulting in the operation remaining at state S0 202. In state S1 204, a user may have twice caused a rotation during operation of state S1 204, resulting in the operation remaining at state S1 204. In state S2 206, a user may have twice caused a rotation during operation of state S2 206, resulting in the operation remaining at state S2 206. In state S3 208, a user may have twice caused a rotation during operation of state S3 208, resulting in the operation remaining at state S3 208. In state S5 210, a user may have twice caused a rotation during operation of state S5 210, resulting in the operation remaining at state S5 210. In state S4 212, a user may have twice caused a rotation during operation of state S4 212, resulting in the operation remaining at state S4 212.

Furthermore, in state S1 204, a user may have selected a back button, either once or through a double-selection such as a double-click, resulting in operation moving to S0 202. In state S2 206, a user may have selected a back button, either once or through a double-selection, resulting in operation moving to S0 202. In state S5 210, a user may have selected a back button, either once or through a double-selection, resulting in operation moving to S0 202.

In state S3 208, a user may have selected a back button through a single-selection, resulting in operation moving to S2 206. Furthermore, in state S3 208, a user may have selected a back button through a double-selection, resulting in operation moving to S0 202.

In state S4 212, a user may have selected a back button through a single-selection, resulting in operation moving to S5 210. Furthermore, in state S4 212, a user may have selected a back button through a double-selection, resulting in operation moving to S0 202.

Returning to FIG. 1, once augmented GUI model 128 has been obtained, test suite extraction module 126 may be configured to determine one or more test sequences to create test suite 108 based upon augmented GUI model 128. In one embodiment, test suite extraction module 126 may be configured to specifically generate test sequences to fully cover the extent of features added by model augmentation module 120. Accordingly, augmented GUI model 128 may retain differences between transitions originally present and transitions added by model augmentation module 120. To determine how to extract such transitions, test suite extraction module 126 may access one or more test oracle modules 124. A test oracle module 124, defining operation of a platform feature, may exist for each such platform feature or type of platform feature.

Test suite extraction module 126 may be configured to extract a set of sequences or paths of GUI operations represented by transitions in augmented GUI model 128 such that every added transition 216 is included in at least one such sequence or path. The set of resultant sequences or paths may be included in test suite 108. Each such sequence or path may originate from a root of GUI model 128. Each such sequence or path may have an individual cost of testing, typically dependent upon the length of the specific sequence or path. Furthermore, there may be another cost of setting up any such tests, which may applied to each of the generated sequences or paths. The costs associated with each of these components may include a constant or factor for each. The most efficient instance of test suite 108 may depend upon such factors such that trade-offs between lengths of sequences and number of sequences may be made. Test suite extraction module 126 may be configured to optimize generation of test suite 108 given the factors associated with the overhead of performing any sequence or path of any length and the factors associated with the execution of all such sequences or paths. For example, the cost may be defined as:

Cost=α*|T|+β*Σ|tᵢ|

“T” may include the set of paths or sequences {t₁, t₂, . . . tₖ} extracted by test suite extraction module 126 to be included in test suite 108. |T| may represent the number of tests included in test suite 108. Inclusion of |T| may therefore include a cost of restarting, initialization, or other overhead for testing a new test sequence. The sum of the number of actions or size of each individual test, represented by |tᵢ|, may thus also be included. Weighting factors, such as α and β, may be applied to each of these elements according to the relative cost of, for example, initialization versus traversal steps taken in the model. These weighting factors may be determined experimentally.

Any suitable algorithm may be used by test suite extraction module 126 to determine test suite 108 such that each portion of augmented GUI model 128 added by augmentation module 120 may be included in at least one path or sequence. Furthermore, such an algorithm may be applied so as to optimally minimize, in any suitable manner, the cost of execution of test suite 108 according to the cost determinations illustrated above.

The algorithm may include, for example, a heuristic algorithm. Such an algorithm may include sorting potential states in augmented GUI model 128 by distance from the source or root of GUI model 128. For each state, test suite extraction module 126 may determine whether the state has any unvisited transitions. For any such unvisited transition, a path may be constructed from the root to the state, and the transition may be added to the path. Furthermore, test suite extraction module 126 may repeat such processes at the new state until a state is reached for which no unvisited transitions have been taken. The path may be added to test suite 108, pending any optimizations. In addition, the process may be repeated for other unvisited transitions from the original state, until not unvisited transitions exist. Further, the process may be repeated for each of the other states.

No matter the algorithm by which test suite extraction module 126 may determine a set of sequences that include each portion of augmented GUI model 128 added by model augmentation module 120, test suite extraction module 126 may perform specific operations in such an algorithm for more creating a more efficient test suite 108. In one embodiment, test suite extraction module 126 may prioritize evaluation of added transitions 216 over transitions 214 when extracting test suite 108 contents from augmented GUI model 128. In another embodiment, test suite extraction module 126 may crop, delete, ignore, or otherwise remove any resultant test sequences or paths that do not include at least one of added transitions 216. In a further embodiment, test suite extraction module 126 may delete, ignore, or otherwise remove any resultant test sequences or paths that only include added transitions 216 for which a test sequence already exists, or for which a more efficient test sequence exists. In yet another embodiment, test suite extraction module 126 may crop, pare, or trim a portion of a given test sequence after the last instance of added transitions 216 in the test sequence.

For example, test suite extraction module 126 may sort every state of augmented GUI model 128 in terms of distance—measured in number of transitions or steps—from the root state. With such a sorted list, test suite extraction module 126 may determine, for a given node, whether each of its transitions out of the node has been traversed. Priority may be given for transitions 216 that were added during creation of augmented GUI model 128 over transitions 214 originally present in GUI model 106. If no unvisited transitions are available, then the node may be considered handled and the next node considered. If unvisited transitions are available, then the steps to get to the node in question may be determined and marked as traversed. A new test path may be computed for the node in question, starting at the node in question. Any suitable new test path determination may be used, such as the one described below. Once the new test path originating from the node has been determined, it may be joined with the path required to get to the node. The combined path may be evaluated by test suite extraction module 126 to determine whether it includes any transitions 216 that were added during creation of augmented GUI model 128. Furthermore, test suite extraction module 126 may determine the combined path includes any such transitions 216 that have not already been covered in a better fashion by another test sequence. If the combined path does not include any such transitions 216, or if the combined path was covered by another test sequence, then it may be discarded by test suite extraction module 126. Otherwise, test suite extraction module 126 may add the combined path to test suite 108.

In order to determine a new test path from a given node, test suite extraction module 126 may use any suitable algorithm or technique. For example, test suite extraction module 126 may start at the given node and determine whether the given node has an unvisited transition. Transitions 216 may be prioritized over transitions 214. If so, an unvisited transition may be taken and added to the test path. The transition may be marked as visited and the new destination node visited. The process may be repeated by test suite extraction module 126 until a node is reached for which there are no unvisited edges.

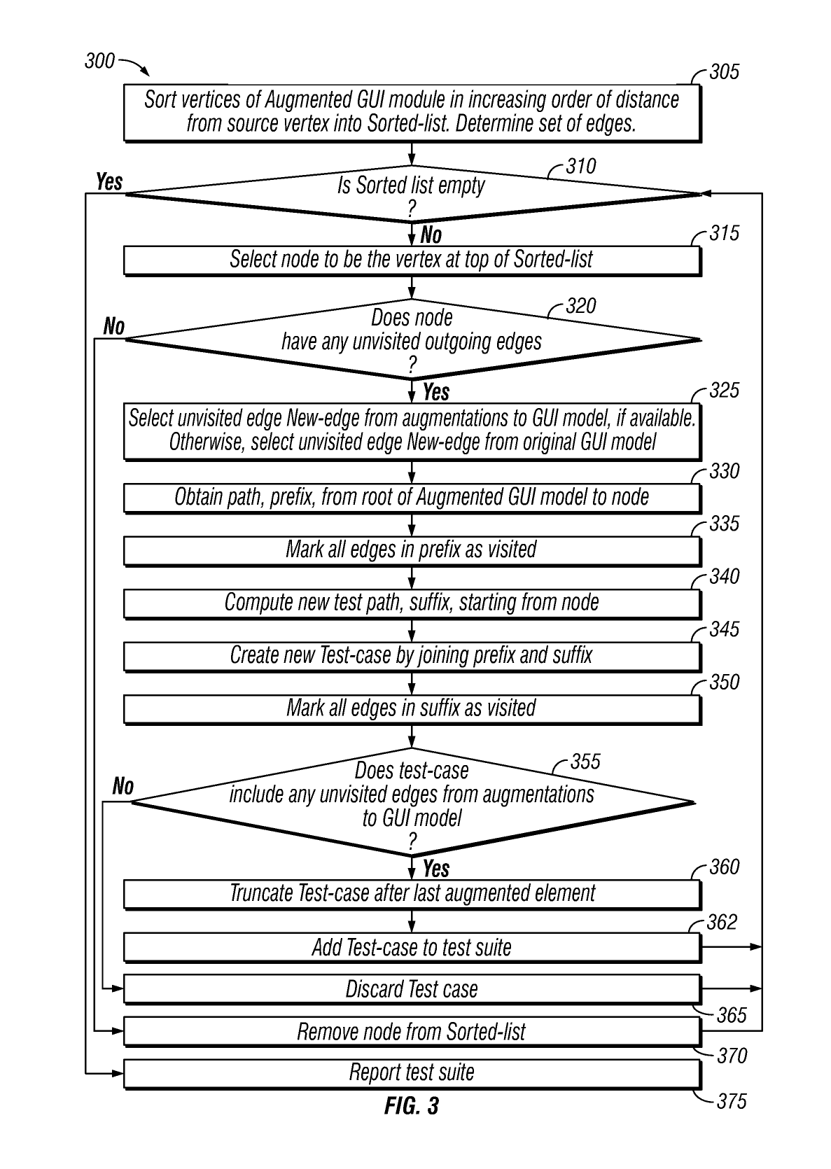

FIG. 3 is an illustration of an example method 300 for test suite extraction. Method 300 may reflect the operations performed fully or in part by test suite extraction module 126 to determine test suite 108 from augmented GUI model 128.

At 305, the vertices, nodes, or states of an augmented GUI, such as augmented GUI model 128, may be sorted in increasing order of distance from a root or source vertex. The sorted order of vertices may be stored in, for example, a Sorted-list. Furthermore, the full set of edges, or transitions, in the model may be determined. The transitions that were originally present in the GUI model may be distinguished from transitions that were added during augmentation of the GUI model.

At 310, it may be determined whether the Sorted-list is empty. If so, method 300 may proceed to 375. If not, at 315 the element at the top of Sorted-list may be designated as node. At 320, it may be determined whether node includes any unvisited outgoing edges. If not, method 300 may proceed to 370. If so, at 325 an unvisited outgoing edge may be selected. The selected edge may be designated as New-edge. Selection of the edge may be performed according to whether an edge was originally within the GUI model or the edge was added during augmentation of the GUI model. Edges that were added during augmentation of the GUI model may be prioritized over edges that were originally present.

At 330, the path from the source or root vertex of the augmented GUI model to node may be determined and designated as prefix. At 335, all edges of prefix may be marked as visited.

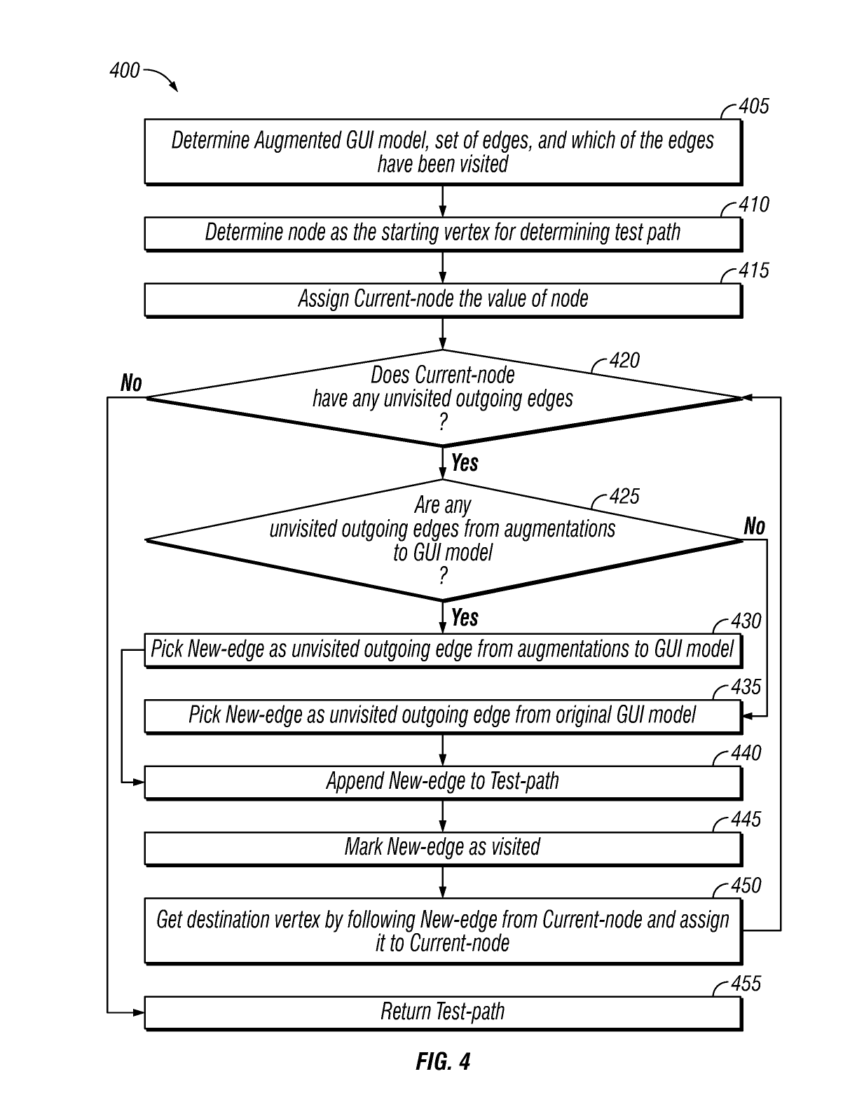

At 340, a new test path originating from node may be determined. Any suitable method or manner of determining such a path may be used. For example, method 400 as illustrated in FIG. 4 may be used for such a determination. The resulting new test path may be designated as suffix.

At 345, a new Test-case may be created by concatenating prefix and suffix. At 350, all edges in suffix may be marked as visited.

At 355, it may be determined whether Test-case should be kept. In one embodiment, Test-case may be kept if it includes an edge or transition created during the augmentation of the GUI model. Furthermore, Test-case may be kept if it includes such an edge or transition that is not already in another Test-case. In addition, Test-case may be kept if it includes such an edge or transition that is in another Test-case, but Test-case is a more efficient expression of such an edge or transition. If Test-case will not be kept at 355, then in 365 Test-case may be discarded, deleted, or otherwise not used. Method 300 may proceed to 310.

If Test-case is to be kept at 355, then at 360 Test-case may be truncated after the last element associated with an augmentation to the GUI model. For example, if Test-case traverses a plurality of elements, the remainder of Test-case may be deleted upon the last such element associated with the augmentations. At 362, Test-case may be added to the resultant test suite, such as test suite 108. Method 300 may proceed to 310.

At 370, node may be removed from Sorted-list, such that another node may now be at the top of Sorted-list and available for analysis.

At 375, the resultant test suite may be reported. Such a test suite may include test suite 108 and may be provided as output of analysis module 102.

FIG. 4 illustrates an example embodiment of a method 400 for determining a new test path given a node. Method 400 may implement fully or in part 340 in association with FIG. 3.

At 405, an augmented GUI model may be determined, as well as a set of edges or transitions associated with the augmented GUI model. Furthermore, it may be determined which of such edges have already been visited.

At 410, a starting vertex or state of the augmented GUI model may be determined and designated as node. At 415, the value of node may be assigned to a placeholder such as Current-node.

At 420, it may be determined whether Current-node has any unvisited outgoing edges or transitions. If not, method 400 may proceed to 455. If so, at 425, it may be determined whether any such unvisited outgoing edges include edges added during the augmentation of the GUI model. If so, at 430, an unvisited edge added during the augmentation of the GUI model may be selected and designated as New-edge. If not, at 435, an edge—which has not yet been visited—may be selected and designated as New-edge.

At 440, the New-edge may be appended to Test-path, if one already exists. If Test-path does not exist, it may be created. At 445, the edge represented by New-edge may be marked as visited. At 450, the destination vertex represented by following New-edge from Current-node may be determined and designated as the new Current-node. Method 400 may proceed to 420.

At 455, the resultant Test-path may be returned.

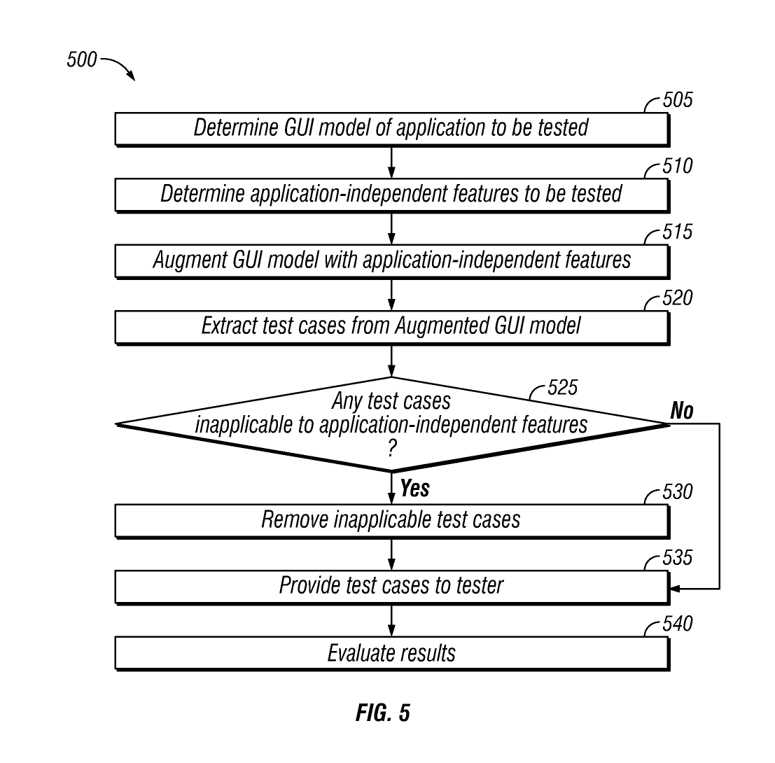

FIG. 5 is an illustration of an example embodiment of a method 500 for automatic feature-driven testing and quality checking of applications.

At 505, a GUI model of an application to be tested may be determined. Such a GUI model may be constructed, generated, or otherwise obtained. The GUI model may include application-specific behaviors.

At 510, application-independent behaviors may be determined. Such application-independent behaviors may be applicable to the application of 505 as well as other applications with respect to a platform. The application-independent behaviors may need testing in conjunction with the application of 505.

At 515, the GUI model may be augmented with behaviors determined in 510. The resultant augmented GUI model may include the original contents of the GUI model in addition to one or more added transitions.

At 520, test cases may be extracted from the augmented GUI model. Such test cases may be extracted by prioritizing coverage of transitions added to the GUI model to yield the augmented GUI model. Such transitions may be prioritized over transitions originally present within the GUI model.

At 525, it may be determined whether any of the test cases do not include transitions added during augmentation of the GUI model. Such test cases may be inapplicable to the application-independent features determined in 510. If so, in 530 such inapplicable test cases may be removed. If not, method 500 may proceed to 535.

At 535, the resultant test cases may be provided to a tester, which may verify that the application performs the requirements detailed therein. The tester may yield results, which may be evaluated at 540.

Although FIGS. 3-5 disclose a particular number of steps to be taken with respect to example methods 300, 400, 500 may be executed with more or fewer steps than those depicted in FIGS. 3-5. In addition, although FIGS. 3-5 disclose a certain order of steps to be taken with respect to methods 900, 1000, the steps comprising methods 300, 400, 500 may be completed in any suitable order. Further, various steps of methods 300, 400, 500 may be conducted in parallel with each other.

Methods 300, 400, 500 may be implemented using the system of FIGS. 1-2 or any other system, network, or device operable to implement methods 300, 400, 500. In certain embodiments, methods 300, 400, 500 may be implemented partially or fully in software embodied in computer-readable media. For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, and other tangible, non-transitory media; and/or any combination of the foregoing.

All examples and conditional language recited above are intended for pedagogical objects to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A method of feature-driven testing by one or more computing devices comprising:
determining a graphical user interface (GUI) model of an application, the application to be executed on a platform, the GUI model including states and transitions;
determining an application-independent feature of the platform;
augmenting the GUI model to reflect the application-independent feature resulting in an augmented model; and
determining a test case from the augmented model, the test case including the application-independent feature.

2. The method of claim 1, wherein augmenting the GUI model includes adding a transition reflecting operation of the application-independent feature.

3. The method of claim 1, wherein the states of the augmented model are substantially equal to the states of the GUI model.

4. The method of claim 1, wherein:
augmenting the GUI model includes adding a new transition reflecting operation of the application-independent feature; and
determining a test case from the augmented model includes, during traversal of the augmented model, prioritization of the new transition over transitions of the GUI model.

5. The method of claim 1, wherein determining a test case from the augmented model includes discarding a traversal path that only includes transitions present in the GUI model.

6. The method of claim 1, wherein the application-independent feature of the platform includes an operation wherein:
the operation at a first state of the GUI model results in remaining in the first state of the GUI model; and
the operation at a second state of the GUI model results in remaining in the second state of the GUI model.

7. The method of claim 1, wherein the application-independent feature of the platform includes an operation wherein:
the operation at a first state of the GUI model results in a transition to a second state of the GUI model; and
the operation at a third state of the GUI model results in a transition to the second state of the GUI model.

8. The method of claim 1, wherein:
augmenting the GUI model includes adding a new transition reflecting operation of the application-independent feature; and
determining a test case from the augmented model includes deleting a portion of the test case after a state including the application-independent feature.

9. The method of claim 1, further comprising:
determining one or more additional test cases from the augmented model, the additional test cases including one or more additional application-independent features of the platform, the test case and the additional test cases forming a test suite; and
optimizing the test suite with respect to a count of the test cases in the test suite and to respective lengths of each test case in the test suite.

10. The method of claim 1, wherein determining a test case from the augmented model includes:
sorting states of the augmented model in terms of distance from a root of the augmented model; and
for a given state of the augmented model:
determining, as a prefix, a path from the root to the state;
determining, as a suffix, a path from the state to a terminal state wherein all transitions have already been taken; and
appending the prefix and the suffix, yielding a test case.

11. A system comprising:
a computer-readable medium comprising computer-executable instructions; and
one or more processors coupled to the computer-readable medium and operable to read and execute the instructions, the one or more processors being operable when executing the instructions to:
determine a graphical user interface (GUI) model of an application, the application to be executed on a platform, the GUI model including states and transitions;
determine an application-independent feature of the platform;
augment the GUI model to reflect the application-independent feature resulting in an augmented model; and
determine a test case from the augmented model, the test case including the application-independent feature.

12. The system of claim 11, wherein augmenting the GUI model includes adding a transition reflecting operation of the application-independent feature.

13. The system of claim 11, wherein the states of the augmented model are substantially equal to the states of the GUI model.

14. The system of claim 11, wherein:
augmenting the GUI model includes adding a new transition reflecting operation of the application-independent feature; and
determining a test case from the augmented model includes, during traversal of the augmented model, prioritization of the new transition over transitions of the GUI model.

15. The system of claim 11, wherein determining a test case from the augmented model includes discarding a traversal path that only includes transitions present in the GUI model.

16. The system of claim 11, wherein the application-independent feature of the platform includes an operation wherein:
the operation at a first state of the GUI model results in remaining in the first state of the GUI model; and
the operation at a second state of the GUI model results in remaining in the second state of the GUI model.

17. The system of claim 11, wherein the application-independent feature of the platform includes an operation wherein:
the operation at a first state of the GUI model results in a transition to a second state of the GUI model; and
the operation at a third state of the GUI model results in a transition to the second state of the GUI model.

18. The system of claim 11, wherein:
augmenting the GUI model includes adding a new transition reflecting operation of the application-independent feature; and
determining a test case from the augmented model includes deleting a portion of the test case after a state including the application-independent feature.

19. The system of claim 11, wherein the one or more processors are further operable to:
determine one or more additional test cases from the augmented model, the additional test cases including one or more additional application-independent features of the platform, the test case and the additional test cases forming a test suite; and
optimize the test suite with respect to a count of the test cases in the test suite and to respective lengths of each test case in the test suite.

20. The system of claim 11, wherein the one or more processors are further operable to:
sort states of the augmented model in terms of distance from a root of the augmented model; and
for a given state of the augmented model:
determine, as a prefix, a path from the root to the state;
determine, as a suffix, a path from the state to a terminal state wherein all transitions have already been taken; and
append the prefix and the suffix, yielding a test case.

21. An article of manufacture comprising:
a computer-readable medium; and
computer-executable instructions carried on the computer-readable medium, the instructions readable by a processor, the instructions, when read and executed, for causing the processor to:
determine a graphical user interface (GUI) model of an application, the application to be executed on a platform, the GUI model including states and transitions;
determine an application-independent feature of the platform;
augment the GUI model to reflect the application-independent feature resulting in an augmented model; and
determine a test case from the augmented model, the test case including the application-independent feature.

22. The article of claim 21, wherein augmenting the GUI model includes adding a transition reflecting operation of the application-independent feature.

23. The article of claim 21, wherein the states of the augmented model are substantially equal to the states of the GUI model.

24. The article of claim 21, wherein:
augmenting the GUI model includes adding a new transition reflecting operation of the application-independent feature; and
determining a test case from the augmented model includes, during traversal of the augmented model, prioritization of the new transition over transitions of the GUI model.

25. The article of claim 21, wherein determining a test case from the augmented model includes discarding a traversal path that only includes transitions present in the GUI model.

26. The article of claim 21, wherein the application-independent feature of the platform includes an operation wherein:
the operation at a first state of the GUI model results in remaining in the first state of the GUI model; and
the operation at a second state of the GUI model results in remaining in the second state of the GUI model.

27. The article of claim 21, wherein the application-independent feature of the platform includes an operation wherein:
the operation at a first state of the GUI model results in a transition to a second state of the GUI model; and
the operation at a third state of the GUI model results in a transition to the second state of the GUI model.

28. The article of claim 21, wherein:
augmenting the GUI model includes adding a new transition reflecting operation of the application-independent feature; and
determining a test case from the augmented model includes deleting a portion of the test case after a state including the application-independent feature.

29. The article of claim 21, further comprising instructions for causing the processor to:
determine one or more additional test cases from the augmented model, the additional test cases including one or more additional application-independent features of the platform, the test case and the additional test cases forming a test suite; and
optimize the test suite with respect to a count of the test cases in the test suite and to respective lengths of each test case in the test suite.

30. The article of claim 21, further comprising instructions for causing the processor to:
sort states of the augmented model in terms of distance from a root of the augmented model; and
for a given state of the augmented model:
determine, as a prefix, a path from the root to the state;
determine, as a suffix, a path from the state to a terminal state wherein all transitions have already been taken; and
append the prefix and the suffix, yielding a test case.
